(19) United States
(12) Patent Application Publication
(10) Pub. No.: US 2008/0272098 A1
(43) Pub. Date: Nov. 6, 2008

(54) METHOD FOR ELECTRIC ARC JOINING

(76) Inventor: Christoph MATZ, Unterschleissheim (DE)

Correspondence Address: The BOC Group, Inc., 575 MOUNTAIN AVENUE, MURRAY HILL, NJ, 07974-2082, US

(21) Appl. No.: 12/110,590

(22) Filed: Apr. 28, 2008

(30) Foreign Application Priority Data
May 4, 2007 (DE) 102007021054.1
Jun. 26, 2007 (EP) 07012514.1

(51) Int. Cl. B23K 1/00

(52) U.S. Cl. 219/129; 219/136

(57) ABSTRACT

To refine a method for electric arc joining, in particular for M[etal] P[rotective] G[as] welding and/or for M[etal] P[rotective] G[as] soldering, of at least one object made of metal and/or at least one metal alloy under protective gas using at least one meltable electrode, at least one mixture made of argon, helium, and at least one active gas being supplied as the protective gas, in such a manner that arbitrary electric arc joining technologies, in particular M[etal] P[rotective] G[as] welding and/or M[etal] P[rotective] G[as] soldering, may be performed in parallel and/or in sequence using the supplied protective gas, it is suggested that the protective gas have
helium in a range from approximately 25 volume-percent (vol.-%) to approximately 30 vol.-%,
carbon dioxide, oxygen, or a carbon dioxide-oxygen mixture in a range from approximately 0.5 vol.-% b to approximately 0.9 vol.-%, and
argon in the remaining volume range.

### CROSS REFERENCE TO RELATED APPLICATIONS

This application claims priority from European Patent Application No. 07012514.1, filed Jun. 26, 2007, which claims priority from German Patent Application No. 102007021054.1, filed May 4, 2007.

### BACKGROUND OF THE INVENTION

The present invention relates to a method for electric arc joining, in particular for M[etal] P[rotective] G[as] welding and/or for M[etal] P[rotective] G[as] soldering, of at least one object made of metal and/or at least one metal alloy under protective gas using at least one meltable electrode, at least one mixture made of argon, helium, and at least one active gas being supplied as the protective gas.

Electric arc joining under protective gas is a frequently used joining technology which particularly comprises arc welding and arc soldering. Furthermore, electric arc joining also includes the bonding of materials of different types, one material being fused while the other material is only heated.

In arc welding, an electric arc burns between an electrode situated in a burner and the workpiece to be processed. A weld bond arises by fusion of the base material at the processing point in the electric arc and subsequent re-solidification of the material.

Arc soldering under protective gas is a joining technology which also provides a material bond using an electric arc. However, only the auxiliary material is fused for the bond and not—as in arc welding—base material and auxiliary material. The soldered bond arises by cramping of the auxiliary material to the base material.

In electric arc joining under inert gas, the auxiliary material is usually introduced into the bond in the form of a meltable electrode. Inter alia, it allows the joining of thin sheets, in particular sheets having a thickness of up to approximately 3 mm.

The electric arc itself is a plasma made of ionized gas and metal vapor in various proportions. In this way, the physical properties of the supplied protective gases or processing gases act directly and rapidly on the electric arc. In addition, the supplied protective gases come into contact with the hot material while forming a highly reactive area, in which the chemical and metallurgical effects of the gases are additionally important.

A protective gas is frequently used for metal protective gas joining, which, in addition to the inert base made of argon or helium, also contains small quantities of active gases, such as oxygen (O₂) or carbon dioxide (CO₂), to influence the weld bond in accordance with the special technological requirements, the active gas component ensuring better fusion or lower surface tension of the melt, for example. The inert gas, such as a noble gas (mixture) made of argon and/or helium, protects the liquid metal under the electric arc from oxidation.

For economic reasons, inter alia, in M[etal] P[rotective] G[as] joining, mixed gases made of argon with oxygen and/or with carbon dioxide have prevailed. An increasing degree of mechanization and elevated use of pulse technology have made mixed gases having reduced oxygen or carbon dioxide proportion more and more beloved. However, less active gases also result in less heat introduction, which may be disadvantageous in regard to fusion and in regard to welding performance.

To improve the efficiency of the heat transfer from the electric arc to the joint in low-activity gases and to improve the efficiency of the electric arc, helium or oxygen is admixed to the protective gas (cf. document “Leistung durch Innovation und Kompetenz. Die Linde Schweiβschutzgase. [Performance through Innovation and Competence. The Linde Welding Protective Gases]”, catalog no. 43385260 0805-1.5 Au).

The protective gas supplied during electric arc joining is typically selected according to
the requirements on the weld bond,
the working position,
the type of the auxiliary material,
the material thickness and the surface state of the base materials,
the degree of mechanization, and
the type of electric arc.

For example, the use of a protective gas for joining a varying-type bond made of two different materials is known from the publication EP 1 321 218 A2, the protective gas having
active gas in a proportion range from 0.005 volume-percent (vol.-%) to 0.1 vol.-%,
helium in a proportion range from 10 vol.-% to 30 vol.-%, and
argon.

Furthermore, a gas mixture for metal protective gas joining (MPG joining) using alternating polarity is disclosed in the publication EP 1 491 278 A2, the gas mixture having argon and/or helium and 0.1 vol.-% to 12 vol.-% oxygen and/or 0.1 vol.-% to 12 vol.-% carbon dioxide.

A protective gas mixture made of argon and 10% carbon dioxide is typically supplied for the metal-protective gas welding (MPG welding) of unalloyed or low-alloy thin sheets. This protective gas is sold by Linde under the trade name CORGON 10.

In contrast, a protective gas mixture made of argon and 2.5% carbon dioxide is typically supplied for the metal-protective gas welding (MPG welding) of alloyed, in particular high-alloy thin sheets. This protective gas is sold by Linde under the trade name CRONIGON 2.

Pure argon or a mixture made of argon and 1% oxygen is typically supplied for metal-protective gas soldering (MPG soldering), however. This protective gas is sold by Linde under the trade name CRONIGON S1.

In protective gas applications which work with various joining technologies and/or various materials, an individual gas supply of this type, in which multiple different gas supply steps must be provided, is time-consuming and costly, however.

### BRIEF SUMMARY OF THE INVENTION

Proceeding from the disadvantages and impossibilities described above and taking the outlined prior art into consideration, the present invention is based on the object of refining a method of the type cited at the beginning in such a manner that arbitrary electric arc joining technologies, in particular M[etal] P[rotective] G[as] (MPG) welding and/or M[etal] P[rotective] G[as] (MPG) soldering, may be performed in parallel and/or in sequence using the supplied protective gas.

This object is achieved by a method having the features specified in claim 1. Advantageous embodiments and expedient refinements of the present invention are characterized in the particular subclaims.

The present invention is thus based on the supply of protective gas having reduced active proportion, for example, in the form of low-activity multipurpose gas, in particular for thin sheet applications and/or for electric arc joining technologies in the automobile industry.

### DETAILED DESCRIPTION OF THE INVENTION

According to the invention, the supplied protective gas has
helium in a range from approximately 25 volume-percent (vol.-%) to approximately 30 vol.-%,
carbon dioxide, oxygen, or carbon dioxide-oxygen mixture in a range from approximately 0.5 vol.-% to approximately 0.9 vol.-%, and
argon in the remaining volume range.

This protective gas may be used simultaneously and/or in sequence for various electric arc joining technologies, for example, for welding applications
on the basis of M[etal] P[rotective] G[as] welding of unalloyed or high-alloy thin sheets, in particular sheet steel, and
on the basis of M[etal] P[rotective] G[as] soldering of coated and/or high-alloy thin sheets, in particular sheet steel.

The method according to the invention may be used both in joining procedures which work with direct current and also in joining procedures operating using alternating current. It is especially preferably usable in electric arc joining using direct current.

The protective gas may have, for example, approximately 25 vol.-% to approximately 28 vol.-% helium and/or approximately 0.75 vol.-% to approximately 0.8 vol.-% carbon dioxide.

In an especially advantageous embodiment of the present invention, the protective gas comprises approximately 30 vol.-% helium, approximately 0.8 vol.-% carbon dioxide, and argon in the remaining volume range.

The present invention is particularly suitable for use for all protective gas applications of the automobile industry on sheet metal having a thickness up to approximately 3 mm (so-called thin sheet).

The method according to the invention has the advantage that a central gas supply using only one gas is performed both for metal-protective gas welding of unalloyed steel or of alloyed steel and also for metal-protective gas soldering. In the prior art, in contrast
a protective gas mixture made of argon and 10% carbon dioxide is supplied for the MPG welding of unalloyed or low-alloy thin sheets,
a protective gas mixture made of argon and 2.5% carbon dioxide is supplied for the MPG welding of alloyed, in particular high-alloy thin sheets, and
pure argon or a mixture made of argon and 1% oxygen is supplied for metal protective gas soldering.

Furthermore, the present invention relates to the use of at least one protective gas, having
helium in a range from approximately 25 vol.-% to approximately 30 vol.-%,
active gas in a range from approximately 0.5 vol.-% to approximately 0.9 vol.-%, and
argon in the remaining volume range, as a low-activity multipurpose gas for electric arc joining, in particular for M[etal] P[rotective] G[as] joining, of at least one object made of metal and/or at least one metal alloy, in particular at least one thin sheet, under protective gas. The electric arc joining is advantageously performed using at least one meltable electrode.

The multipurpose gas advantageously has
helium in a range from approximately 25 vol.-% to approximately 28 vol.-% and/or
carbon dioxide in a range from approximately 0.75 vol.-% to approximately 0.8 vol.-%.

Because the present multipurpose gas is a product which may be used in multiple methods, specific advantages result as a function of the precise composition for the various areas of use, in particular for various materials and/or for various thickness ranges of the object.

Fundamentally, any of the above-mentioned gases which may be supplied according to the invention provide good results in electric arc joining. A multipurpose gas especially suitable, in particular for an object having a thickness of approximately 0.6 mm to approximately 3 mm, comprises approximately 30 vol.-% helium, approximately 0.8 vol.-% carbon dioxide, and argon in the remaining volume range.

If the focus of the electric arc joining is in the upper thickness range of a thin sheet, for example, the supplied protective gas or multipurpose gas advantageously has a relatively high content of carbon dioxide and more helium. If the object has a thickness of approximately 3 mm, for example, a multipurpose gas which comprises approximately 30 vol.-% helium, approximately 0.9 vol.-% carbon dioxide, and argon in the remaining volume range is especially suitable.

In contrast, a multipurpose gas having lower carbon dioxide and helium content is preferred for electric arc joining of a very thin object. If the object has a thickness of approximately 1 mm, for example, a multipurpose gas which comprises approximately 25 vol.-% helium, approximately 0.6 vol.-% carbon dioxide, and argon in the remaining volume range is especially suitable for the electric arc joining.

Carbon dioxide and helium support the heat transport and generate deeper fusion on the component, which may be desirable for an approximately 3 mm thick object, but is not required for a thin object, for example, for sheet metal of approximately 1 mm thickness.

It has been shown that even in thin sheets having up to approximately 3 mm wall thickness, a significant distance exists in the heat dissipation between thin and thick thin sheets. A factor of five still exists between the common minimum wall thickness of approximately 0.6 mm and the common maximum wall thickness of approximately 3 mm, which causes significantly higher heat dissipation. A higher carbon dioxide and/or helium proportion counteract this.

Surprisingly, with the method according to the invention and the use according to the invention, not only are various gas supply steps saved, but rather also improved joining properties are achieved in comparison to the prior art.

Thus, less scale is formed with the protective gas supplied according to the invention than with the protective gas mixture made of argon and 10% carbon dioxide (trade name CORGON 10) and better gap bridging is achieved, in addition, less spattering occurring.

Less oxidation and a higher welding speed are achieved with the protective gas supplied according to the present invention than with the protective gas mixture made of argon and 2.5% carbon dioxide (trade name CRONIGON 2).

Furthermore, improved soldering properties, in particular a higher soldering speed, less spattering ejection, better flowing and wetting behavior, and better seam appearance are achieved in the method according to the present invention than with the supply of argon or a mixture made of argon and 1% oxygen (trade name CRONIGON S1).

What we claim is:

1. A method for electric arc joining, of at least one object made of metal and/or at least one metal alloy under protective gas using at least one meltable electrode, at least one mixture made of argon, helium, and at least one active gas being supplied as the protective gas,
characterized in that,
the protective gas has helium in a range from approximately 25 volume-percent (vol.-%) to approximately 30 vol.-%; carbon dioxide, oxygen, or a carbon dioxide-oxygen mixture in a range from approximately 0.5 vol.-% to approximately 0.9 vol.-%, and argon in the remaining volume range.

2. The method as claimed in claim 1 wherein said electric arc joining is selected from the group consisting of M[etal] P[rotective] G[as] welding and M[etal] P[rotective] G[as] soldering.

3. The method according to claim 1, characterized in that the object has a thickness of at most approximately 3 mm.

4. The method according to claim 1, characterized in that the object has a thickness of a thin sheet.

5. A use of at least one protective gas, comprising helium in a range from approximately 25 vol.-% to approximately 30 vol.-%, active gas in a range from approximately 0.5 vol.-% to approximately 0.9 vol.-%, and argon in the remaining volume range, as a low-activity multipurpose gas for electric arc joining, selected from the group consisting of M[etal] P[rotective] G[as] welding and M[etal] P[rotective] G[as] soldering, of at least one object made of metal and/or at least one metal alloy under protective gas using at least one meltable electrode.

6. The use according to claim 5, characterized in that the multipurpose gas has helium in a range from approximately 25 vol.-% to approximately 28 vol.-%.

7. The use according to claim 5, characterized in that the multipurpose gas has carbon dioxide in a range from approximately 0.75 vol.-% to approximately 0.8 vol.-%.

8. The use according to claim 5, characterized in that the multipurpose gas comprises approximately 30 vol.-% helium, approximately 0.8 vol.-% carbon dioxide, and argon in the remaining volume range.

9. The use according to claim 5, characterized in that the object has a thickness of at most approximately 3 mm.

10. The use according to claim 5, characterized in that the object has a thickness of a thin sheet.

11. The use according to claim 9, characterized in that the multipurpose gas comprises approximately 30 vol.-% helium, approximately 0.9 vol.-% carbon dioxide, and argon in the remaining volume range; and the object has a thickness of approximately 3 mm.

12. The use according to claim 9, characterized in that the multipurpose gas comprises approximately 25 vol.-% helium, approximately 0.6 vol.-% carbon dioxide, and argon in the remaining volume range; and the object has a thickness of approximately 1 mm.

13. The use according to claim 5 in the automobile industry.
